(19) United States
(12) Patent Application Publication
(10) Pub. No.: US 2008/0271394 A1
(43) Pub. Date: Nov. 6, 2008

(54) Frame assembly for the opening of a structure

(75) Inventors: Richard S. Hand, Pace, FL (US); Fred C. Higgins, Pensacola, FL (US); Kevin A. Seiling, Monaca, PA (US); William G. Roberts, Beaver Falls, PA (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignees: Wayne-Dalton Corp.; Veka, Inc.

(21) Appl. No.: 11/799,542

(22) Filed: May 2, 2007

(51) Int. Cl. E06B 1/04

(52) U.S. Cl. 52/210

(57) ABSTRACT

A frame assembly may be secured within an opening in a structure and is adapted to carry a window assembly therein. The frame assembly may include a pair of spaced vertical rails and a top rail secured to a top end of the vertical rails. A bottom rail may be secured to a bottom end of the vertical rails and the window assembly is removable without damaging the underlying structure.

### TECHNICAL FIELD

This invention relates to frame assembly which may be received in and secured to a building opening. The frame assembly receives a window or door assembly in a manner that improves environmental seal and permits easy replacement.

### BACKGROUND

The method of installing a window or door in a building opening has not changed much over the years. The framework is typically formed of wood based products, but could also be metal such as steel. Typically, an opening is formed in the structural framework and once formed, a window assembly is positioned in the opening, shimmed, and secured to the frame by driving fasteners through the jambs of the window.

Such methods have drawbacks. For example, obtaining an adequate environmental seal around the windows is difficult, particularly when shimming is required. A quality seal is particularly important in tropical areas that experience both high winds and heavy rainfall. During high wind events, water may wick or migrate into the interior of a building if seals are not properly positioned.

Prior art window installations are also inadequate in that removal and replacement of such windows is difficult and often results in structural damage to the building structure. Also, more modern window openings include protective covers that may be raised and lowered to selectively cover and protect the opening adjacent high wind events such as hurricanes or the like. Installation of such protective covers often requires costly retrofitting of the window opening.

Therefore, there is a need in the art for a frame assembly mountable within a building opening that receives a window or door assembly, achieves improved sealing, carries a protective cover, and allows for easier replacement of the window or door assembly.

### SUMMARY OF THE INVENTION

It is thus an object of the present invention to provide a frame assembly that receives a window assembly and has advantageous sealing properties.

It is another object of the present invention to provide a frame assembly that prevents damage to a structure when replacing a window assembly.

It is still another object of the present invention to provide a frame assembly that incorporates a protective curtain and receives a window assembly.

These and other objects of the present invention, as well as the advantages thereof over the prior assemblies, which will become apparent from the description to follow, are accomplished by the improvements hereinafter described and claimed.

In general an assembly made according to the present invention is securable within an opening in a structure and is adapted to carry a window assembly. The frame assembly includes a pair of spaced vertical rails and a top rail secured to a top end of the vertical rails. A bottom rail is secured to a bottom end of the vertical rails. All of the rails are adapted to engage the window assembly so that the window assembly may be removed from the frame assembly without damaging the structure.

In accordance with another aspect of the present invention, a frame assembly is adapted to mount within an opening in a structure and receive a window or door assembly. The frame assembly includes a pair of spaced vertical rails. A top rail is secured to a top end of the vertical rails. A bottom rail is secured to a bottom end of the vertical rails. A storage area is positioned at the top rail, and a protective cover is carried in the storage area.

In accordance with yet another aspect of the present invention, a frame assembly is adapted to mount within an opening in a structure and receive a window having a bottom sill with one or more drainage holes. The frame assembly includes a pair of spaced vertical rails, and a top rail secured to a top end of the vertical rails. A bottom rail is secured to a bottom end of the vertical rails. The bottom rail includes at least one drainage passageway adapted to communicate with the bottom sill drainage hole.

An exemplary frame assembly incorporating the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a perspective view of a frame assembly made in accordance with the present invention.

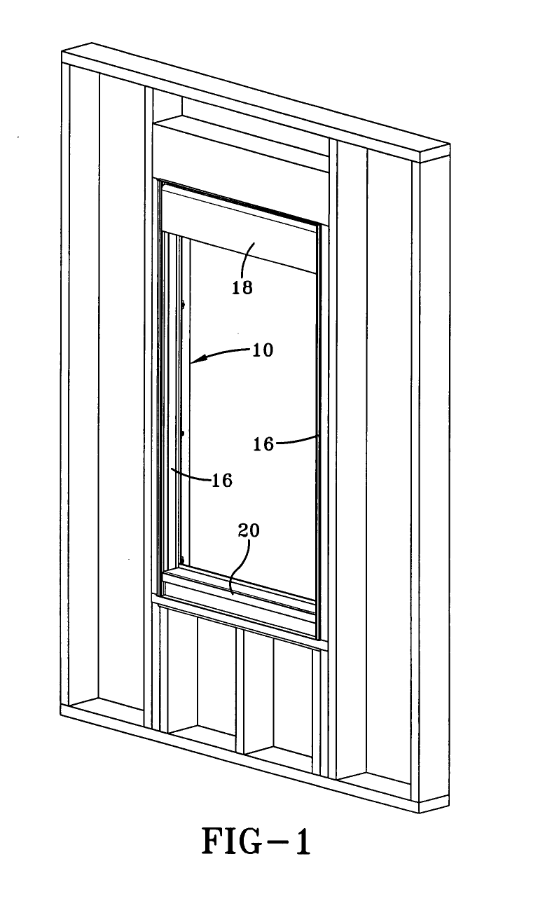

FIG. 2 is a partially exploded view showing the frame and window assemblies.

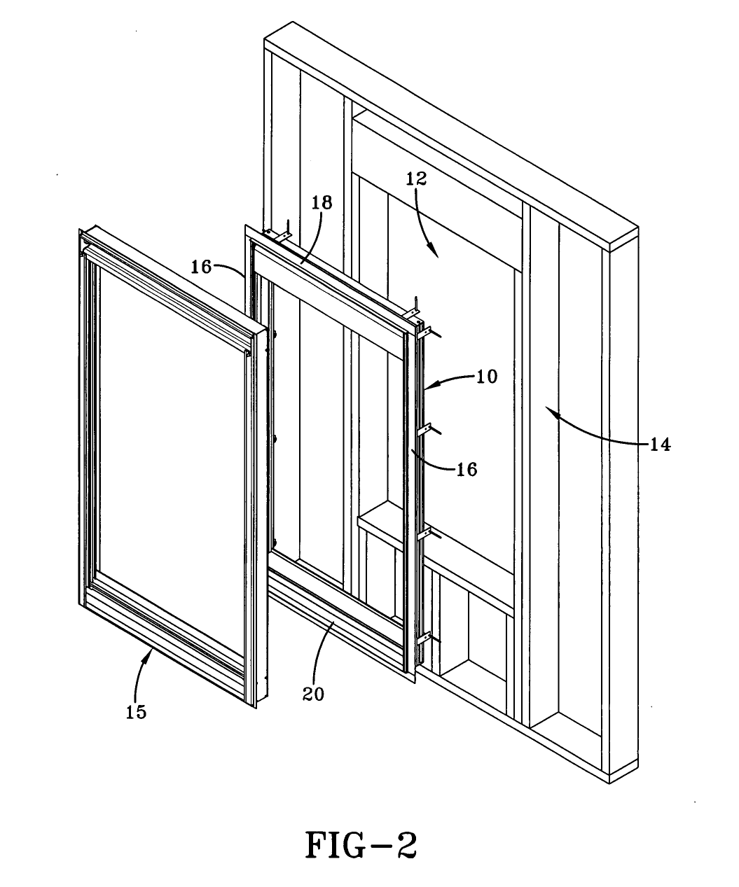

FIG. 3 is an exploded view of the frame assembly.

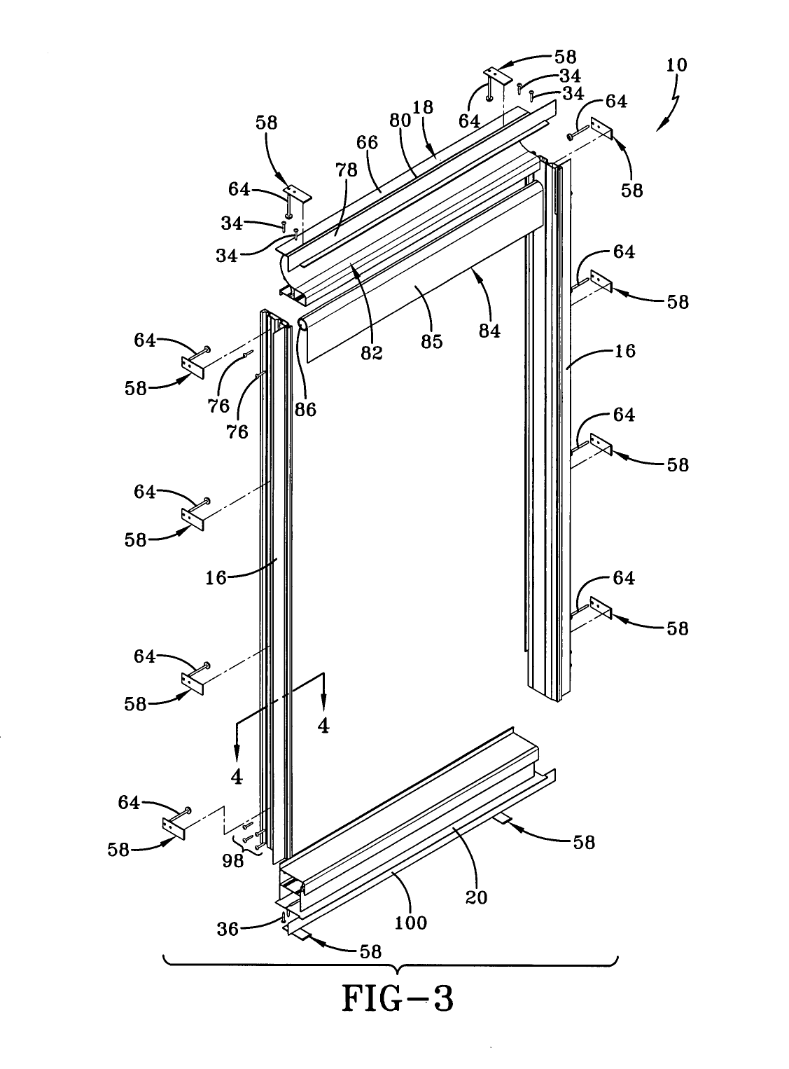

FIG. 4 is a sectional view of the vertical rail taken substantially along line 4-4 of FIG. 3.

FIG. 5 is a fragmented sectional view of the top rail.

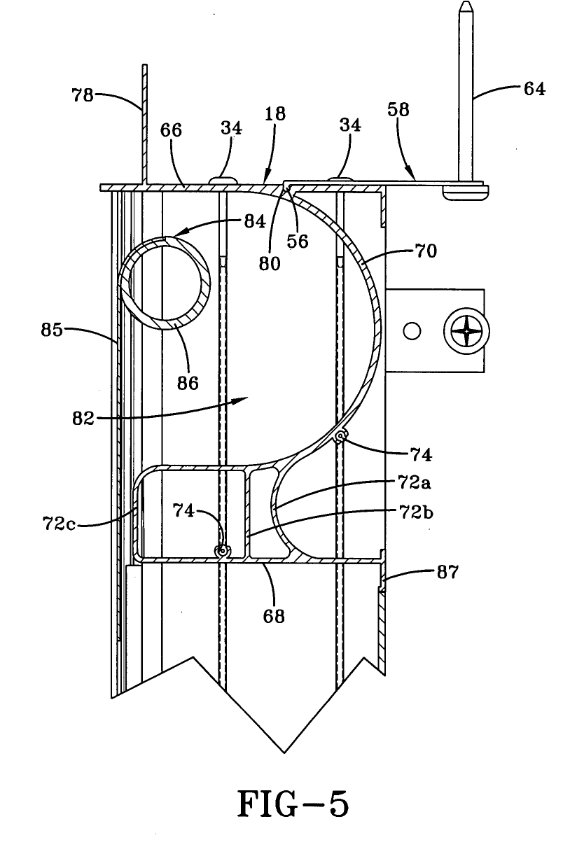

FIG. 6 is an enlarged exploded view of the top rail and curtain assembly.

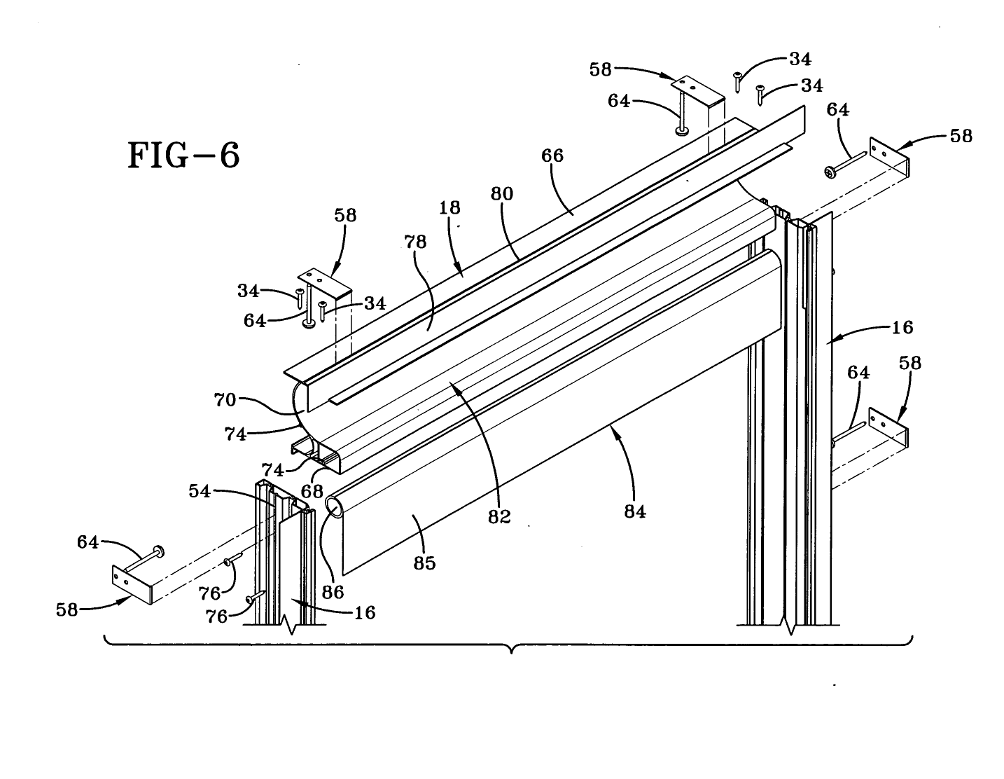

FIG. 7 is a fragmented sectional view of the bottom rail.

FIG. 8 is an enlarged exploded view of the bottom rail.

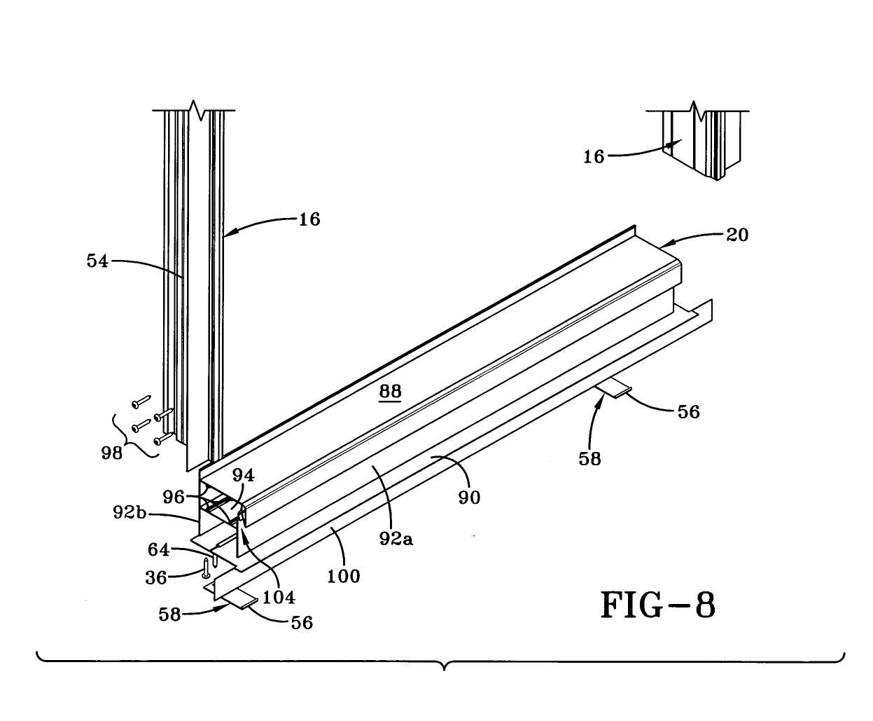

FIG. 9 is an enlarged perspective view showing the assembled frame assembly with clips attached.

FIG. 10 is an exploded elevational view of the frame assembly.

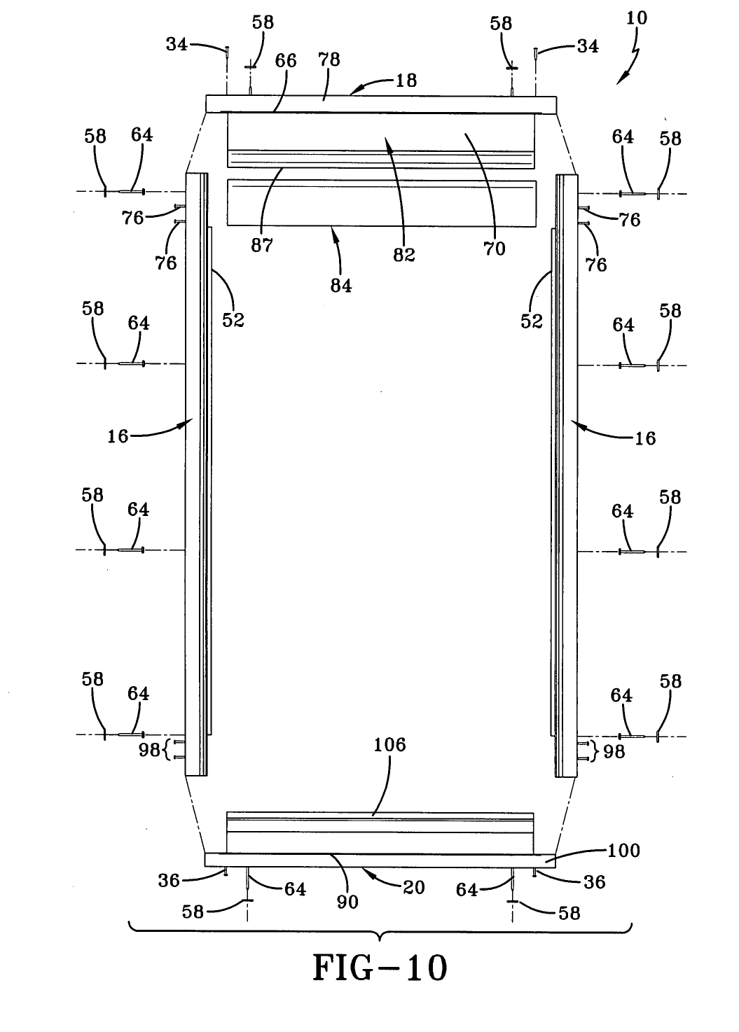

FIG. 11 is a partially exploded view of a plurality of window assemblies positioned for installation in the frame assembly.

FIG. 12 is a perspective view of an alternate frame assembly.

FIG. 13 is an exploded view of the frame assembly of FIG. 12.

FIG. 14 is sectional view of the vertical rail taken substantially along line 14-14 of FIG. 12.

FIG. 15 is an enlarged exploded view of the top and vertical rail.

FIG. 16 is a sectional view of the top rail taken substantially along line 16-16 of FIG. 12.

FIG. 17 is an enlarged exploded view of the top rail and housing.

FIG. 18 is an enlarged perspective end view of the bottom rail.

FIG. 19 is a somewhat schematic end view of the bottom rail and window assembly.

### PREFERRED EMBODIMENTS FOR CARRYING OUT THE INVENTION

A frame assembly made in accordance with one aspect of the present invention is generally indicated by the numeral 10. Frame 10 is a self-contained load supporting structure designed to be mounted in an opening 12 of a structure 14. Once frame 10 is installed, a window 15 or door assembly (not shown) may be removably secured therein without disturbing the area of structure 14 adjoining frame assembly 10. The use of frame 10 makes replacement of window and door assemblies less time consuming and costly and reduces the need to repair the cosmetics of structure 14. Further, it is no longer necessary to replace and repair the seals for resisting water and air infiltration that are typically required during normal door and window replacement.

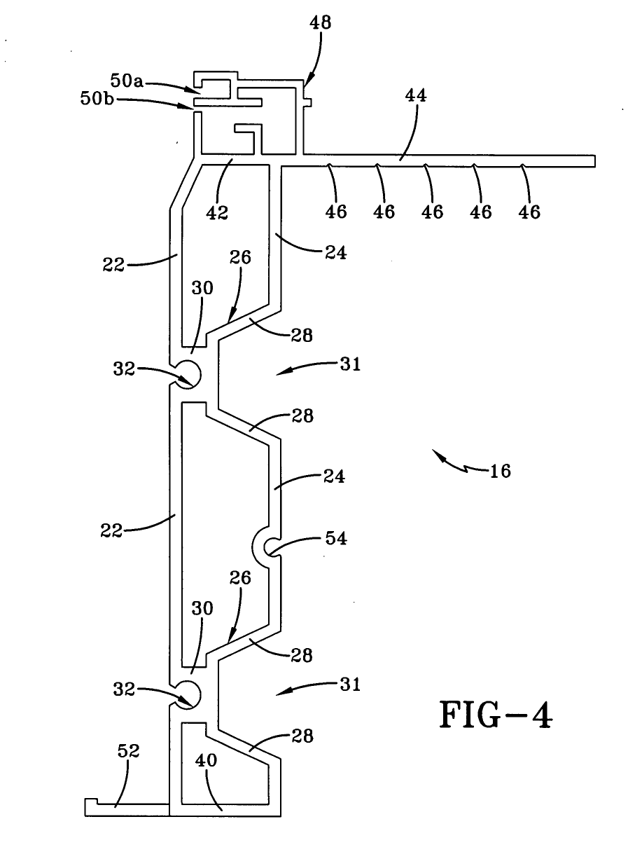

Frame assembly 10 may include a pair of vertical rails 16, a top rail 18 and a bottom rail 20. Referring now to FIG. 4, vertical rails 16 in end view, include a first wall 22 and a second wall 24 oriented in a spaced relation. First wall 22 provides a substantially planar surface that contacts and supports window assembly 15. A pair of linking portions generally indicated by the numeral 26 interconnect first wall 22 and second wall 24 along the vertical length to improve strength and rigidity. Linking portions 26 each include angled walls 28 that extend from second wall 24 toward first wall 22 and terminate at a connecting wall 30 which in turn extends to first wall 22. Angled walls 28 and connecting wall 30 form recessed areas 31 that run along the vertical length of vertical rails 16. These recessed areas 31 may be used as receiving areas for the fasteners used to attach the door or window assembly thereto.

Each connecting wall 30 further includes an integral fastener aperture 32 that runs along the vertical length thereof. Screws 34 are inserted through top rail 18 and into fastener apertures 32 to couple top rail 18 and vertical rails 16 together. Similarly, screws 36 are inserted through bottom rail 20 and into fastener apertures 32 to couple bottom rail 20 and vertical rails 16 together.

First wall 22 and second wall 24 each terminate at an interior facing wall 40 and at the opposed side at an exterior facing wall 42. A mounting flange 44 extends outwardly from exterior facing wall 42 and is adapted to be positioned flush against the structure and provide a sealing interface. Fasteners (not shown) may be driven through mounting flange 44 and into structure 14 to secure frame assembly 10 to structure 14. Mounting flange 44 may include a plurality of vertically extending notches 46 that may be used by an installer to adjust the size of mounting flange 44. Specifically, an installer may bend and break the mounting flange 44 along any one of the notches 46 to adjust the lateral width of the flange 44.

A channel 48 extends the vertical length of vertical rail 16 and is positioned proximate to exterior facing wall 42. Channel 48 may include one or more inwardly open channels 50a and 50b that are adapted to receive and guide a protective curtain assembly, as will be hereinafter described. Multiple channels may be provided to accommodate a plurality of curtain assembly types and/or styles.

A sealing area 52 may be provided to extend inwardly from interior facing wall 40. Sealing area 52 allows an application of a sealing compound during installation of window assembly 15 to prevent water and air infiltration into structure 14 between frame assembly 10 and window assembly 15.

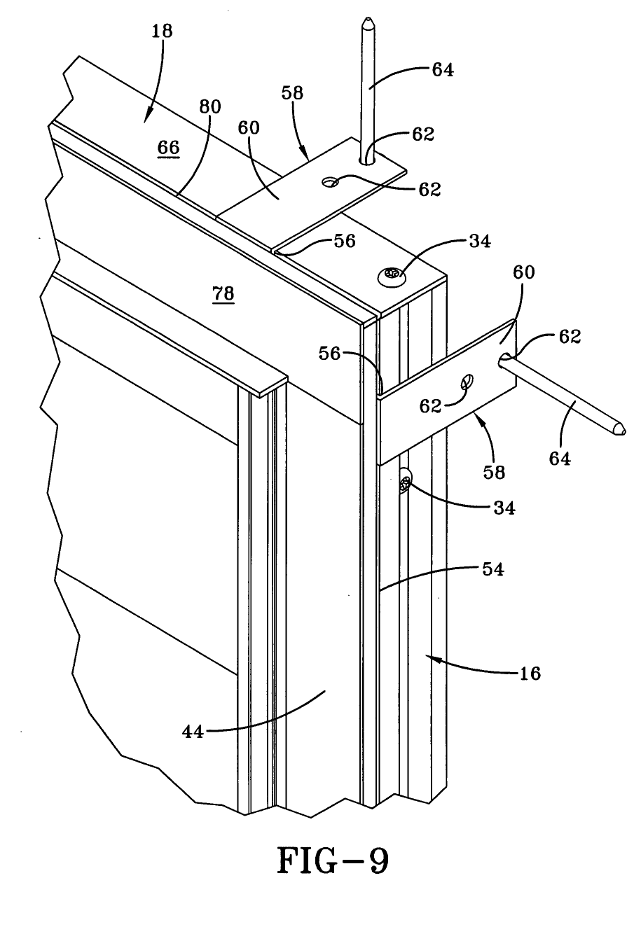

A locking groove 54 extends the vertical length of second wall 24 and is adapted to receive the cylindrical insert 56 of a clip 58 (FIG. 9). Clips 58 include a generally flat rectangular portion 60 that includes one or more apertures 62 located proximate to the end opposed from cylindrical insert 56. In use, cylindrical insert 56 is inserted into groove 54 and then fasteners 64 are driven into structure 14 through apertures 62. In this manner, a plurality of clips 58 secure frame assembly 10 to structure 14. Clips 58 may be positioned at any point along vertical rail 16 and any number may be used. Such gives the installer significant flexibility during installation of frame assembly 10 and results in a decrease of installation time.

Top rail 18 includes a top wall 66 and an opposed bottom wall 68. A curved inner wall 70 extends downwardly from top wall 66, and a plurality of connecting walls 72a, 72b and 72c extend downwardly from curved wall 70 and connect to bottom wall 68. One or more fastener apertures 74 are provided so that fasteners 76 may be inserted through vertical rails 16, at recessed portions 31, and into fastener aperture 74 to secure vertical rails 16 to top rail 18.

Top wall 66 further includes an upwardly extending flange 78 that is provided to promote an environmental seal between frame assembly 10 and structure 14. Further, one or more fasteners (not shown) may be driven through flange 78 and into structure 14 to secure frame assembly thereto. Like flange 44, flange 78 may include a plurality of notches (not shown) to allow an installer to modify the size thereof. Top wall 66 further includes a laterally extending locking groove 80. Similar to locking groove 54, locking groove 80 receives the cylindrical insert 56 of clip 58 to secure frame assembly 10 to structure 14.

Top wall 66, bottom wall 68 and curved wall 70 form a chamber 82 that may receive a curtain assembly 84 therein. Curtain assembly includes a curtain 85 that is movable between an open and closed position and is carried by a shaft 86. When in the closed position, curtain 85 covers the entirety of window 15 and prevents solar heat gain while also providing protection against debris or other objects carried by the wind. Exemplary curtain and locking assemblies and methods of their use are taught in co-pending U.S. application Ser. No. ______, titled Assembly to Lock a Storm Curtain Adjacent to an Opening in a Building, and U.S. application Ser. No. ______, titled Assembly to Lock a Storm Curtain Adjacent to an Opening in a Building, each of which are filed concurrently herewith and are hereby incorporated by reference.

A sealing area 87 may be provided and extends downwardly from bottom wall 68. Sealing area 87 allows an application of a sealing compound during installation of window assembly 15 to prevent water and air infiltration into structure 14 between frame assembly 10 and window assembly 15.

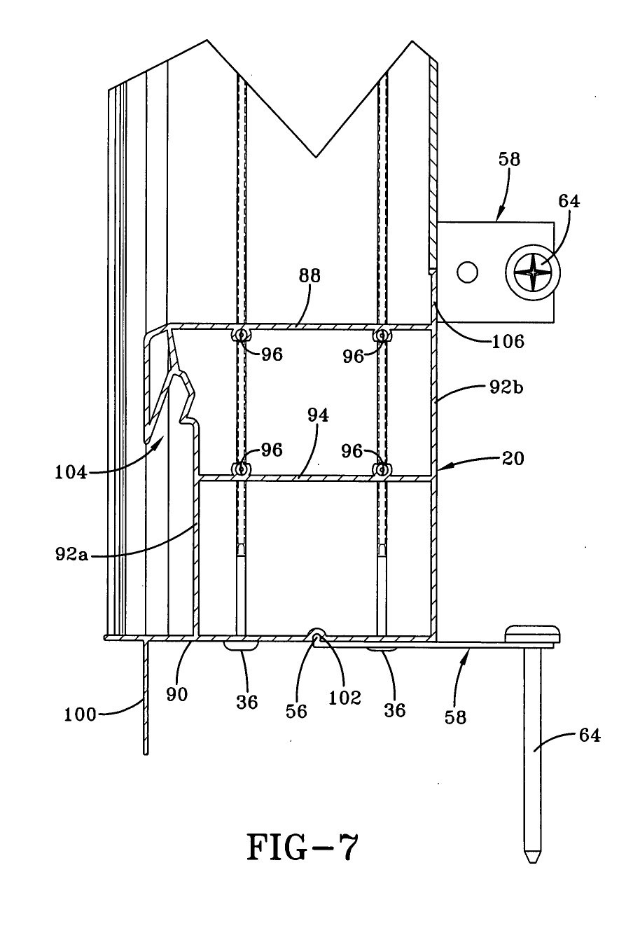

As best shown in FIG. 7, bottom rail 20 includes a top wall 88, a bottom wall 90 and opposed side walls 92a and 92b. A horizontally oriented dividing wall 94 is positioned between top wall 88 and bottom wall 90 and to provide additional strength. A pair of fastener apertures 96 are provided on top wall 88 and dividing wall 94. Fasteners 98 are received through vertical rail 16, at recessed portions 31, and extend into fastener apertures 96 to secure together vertical rails 16 and bottom rail 20.

A flange 100 extends from downwardly from bottom wall 90 to promote an environmental seal between frame assembly 10 and structure 14. Further, one or more fasteners (not shown) may be driven through flange 100 and into structure 14 to secure frame assembly 10 thereto. Bottom wall 90 further includes a laterally extending locking groove 102. Like locking grooves 54, and 80, locking groove 102 receives the cylindrical insert 56 of clip 58 to secure frame assembly 10 to structure 14.

Bottom rail 20 may also include elements adapted to lock the curtain to bottom sill 20. Though any arrangement may be used, the present embodiment includes a locking channel 104 that is adapted to selectively receive a rigid locking element (not shown) that is secured to the bottom of the curtain 85. Bottom rail 20 may also carry various other guiding, locking or derailing elements that are adapted to selectively lock and unlock the curtain in the closed position.

A sealing area 106 may be provided and extends upwardly from top wall 88. Sealing area 106 can receive an application of a sealing compound during installation of window assembly 15 to prevent water and air infiltration into structure 14 between frame assembly 10 and window assembly 15.

Frame assembly 10 may be preassembled at the factory or may be shipped to the building location and assembled on site. Installation is accomplished by inserting frame 10 into the opening 12 until flanges 44, 78 and 100 lie flush against frame 14. Thereafter, fasteners 64 are driven through apertures 62 and into frame 14. In this manner clips 58 hold frame 10 within opening 12. Optionally, fasteners may be driven through flanges 44, 78 and 100 to further secure frame 10 to structure 14.

Once frame assembly 10 is installed, window assembly 15 can be attached thereto in the standard fashion with conventional fasteners (not shown) driven through the jamb areas 108 of window 15 and into vertical rails 16. In one or more embodiments, the fasteners may be driven through jabs 108 and into vertical rails 16 in a manner such that the fasteners are driven through vertical rails 16 at recessed areas 31. In this manner, a window assembly 15 may be quickly and easily mounted within opening 12. Further, removal and replacement of a window is easily done without damaging the structure 14, and frame assembly 10 enables improved water and weather resistance.

Frame assembly 10 may be sized to fit any standard window assembly 15, and may incorporate a protective cover that may be selectively closed and locked to prevent damage to the interior of structure 14. The protective cover, in addition to curtain assembly 84, may include electrical or manual means to move the curtain assembly and/or additional or different locking and guiding elements.

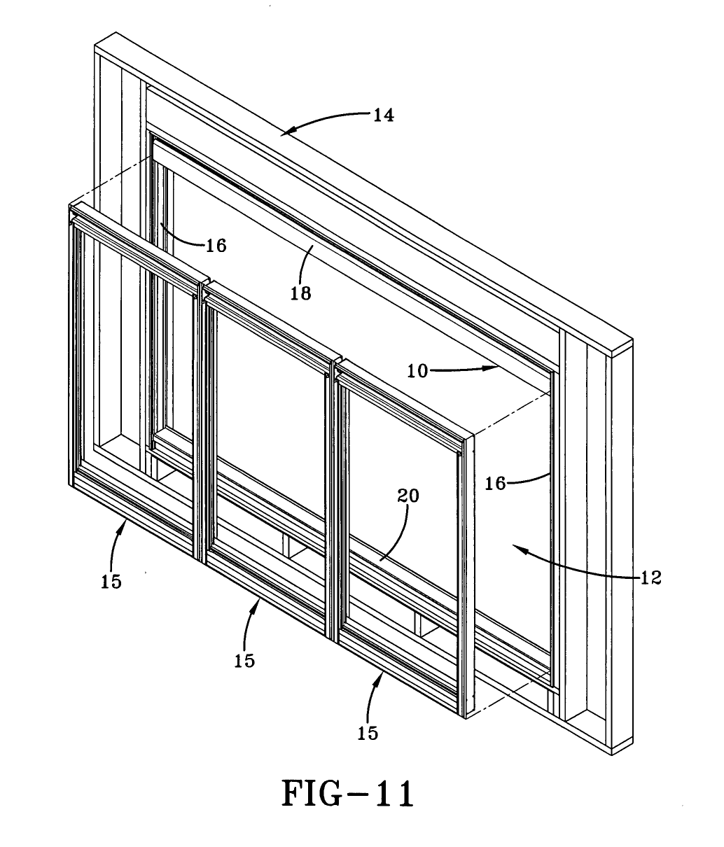

As shown in FIG. 11, frame assembly 10 may also be used to support and receive multiple or mulled window assemblies 15 which may be aligned and installed in the same manner as discussed above.

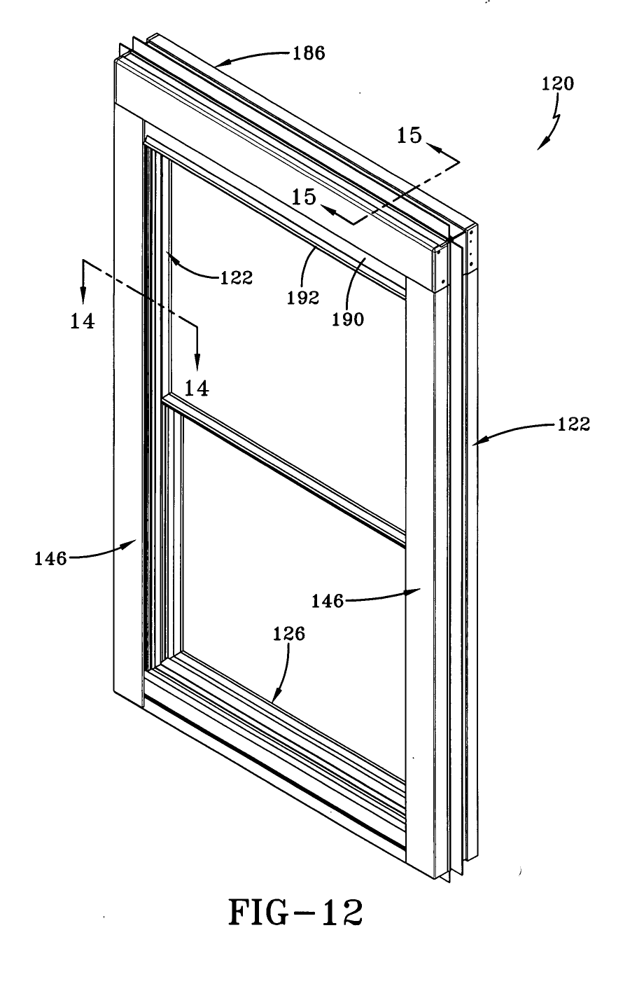

With reference now to FIG. 12, an alternate frame assembly 120 is disclosed. Like frame assembly 10, frame assembly 120 is a self-contained load supporting structure designed to be mounted in an opening 12 of a structure 14. Once frame assembly 120 is installed, a window 15 or door assembly (not shown) may be removably secured therein without disturbing the area of structure 14 adjoining frame assembly 120. The use of frame assembly 120 makes replacement of window and door assemblies less time consuming and costly and reduces the need to repair the cosmetics of structure 14. Further, it is no longer necessary to replace and repair the seals for resisting water and air infiltration that are typically required during normal door and window replacement.

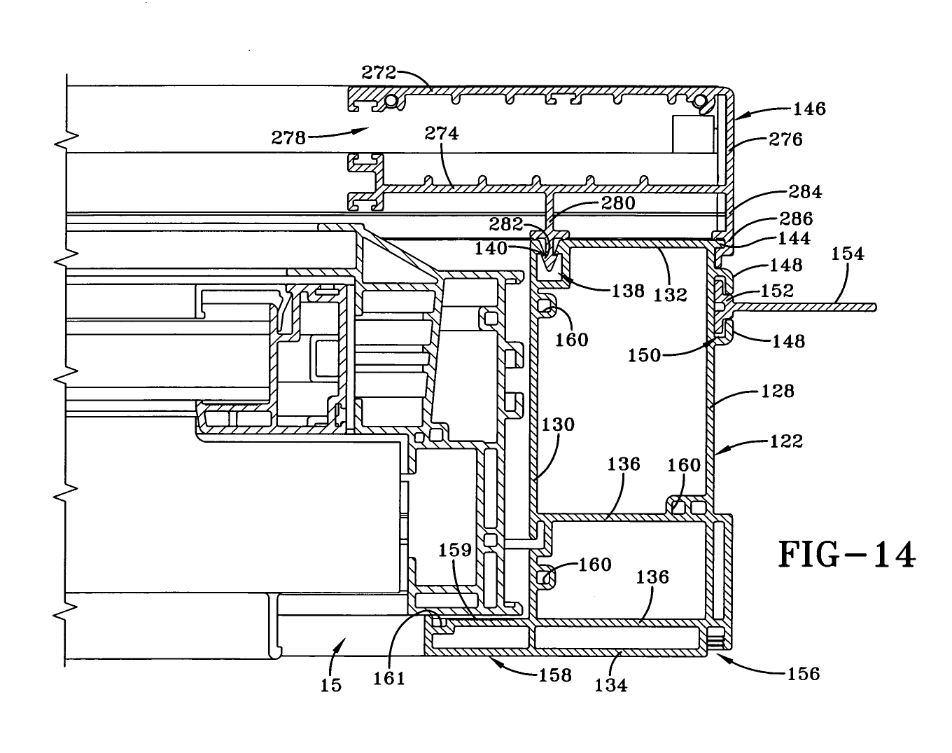

Frame assembly 120 may include opposed vertical rails 122, a top rail 124 and a bottom rail 126. Referring now to FIG. 14, vertical rails 122 in end view, include a first wall 128 spaced from a second wall 130. Second wall 130 provides a substantially planar surface that contacts and supports window assembly 15. First and second walls 128 and 130 terminate at an exterior facing wall 132 and at an opposed interior facing wall 134. A plurality of support walls 136 may be positioned between exterior and interior walls 132 and 134 and span between first and second walls 128 and 130.

A fastening channel 138 is provided at exterior facing wall 132 that extends substantially the entire vertical length of vertical rail 122. A pair of opposed angled fingers 140 are located at the entrance to fastening channel 138. A protrusion 144 extends laterally outward from exterior facing wall 132 along substantially the entire vertical length of vertical rail 122. As will be hereinafter described in more detail, fastening channel 138 and protrusion 144 cooperate to retain a side guide generally indicated by the numeral 146.

A pair of L-shaped legs 148 face each other and extend along substantially the entire vertical length of first wall 128. Legs 148 define a channel 150 that may selectively receive the head 152 of one or more fins 154. Fasteners (not shown) may be driven through fins 154 and into structure 14 to secure frame assembly 120 to structure 14. Frame assembly 120 may also be secured to structure 14 with fasteners (not shown) driven through first and second walls 128 and 130 and into structure 14.

A ribbed notch 156 may be provided proximate to the intersection of first wall 128 and interior facing wall 134. Notch 156 faces the interior of the structure and may receive and retain a decorative trim or other decorative feature. A sealing area 158 is also provided that extends laterally inward from second wall 130. Sealing area 158 may include a ribbed surface 159 that faces exteriorly. A groove 161 is positioned on the laterally inward side of ribbed surface 159 and both groove 161 and ribbed surface 159 are provided to allow an application of a sealing compound and/or industrial adhesive during installation of window assembly 15. This prevents water and air infiltration into structure 14 between frame assembly 120 and window assembly 15 and helps secure window assembly 15 to frame assembly 120.

Vertical rail 122 includes a plurality of fastener apertures 160. As will be hereinafter described in more detail, fasteners 162 are inserted through top rail 124 and into fastener apertures 160 to secure together top rail 124 and vertical rail 122.

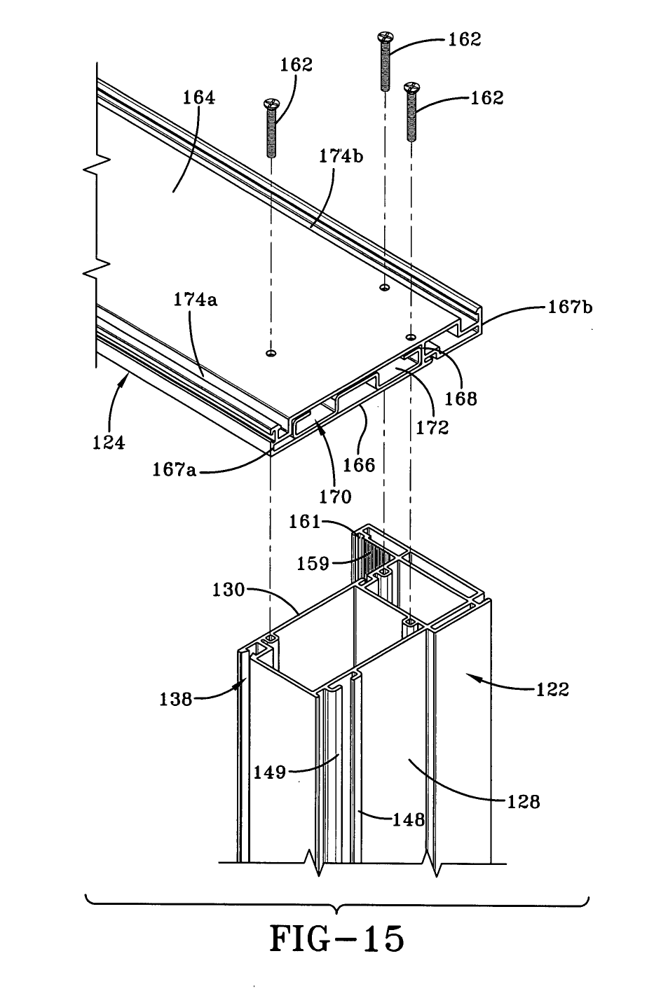

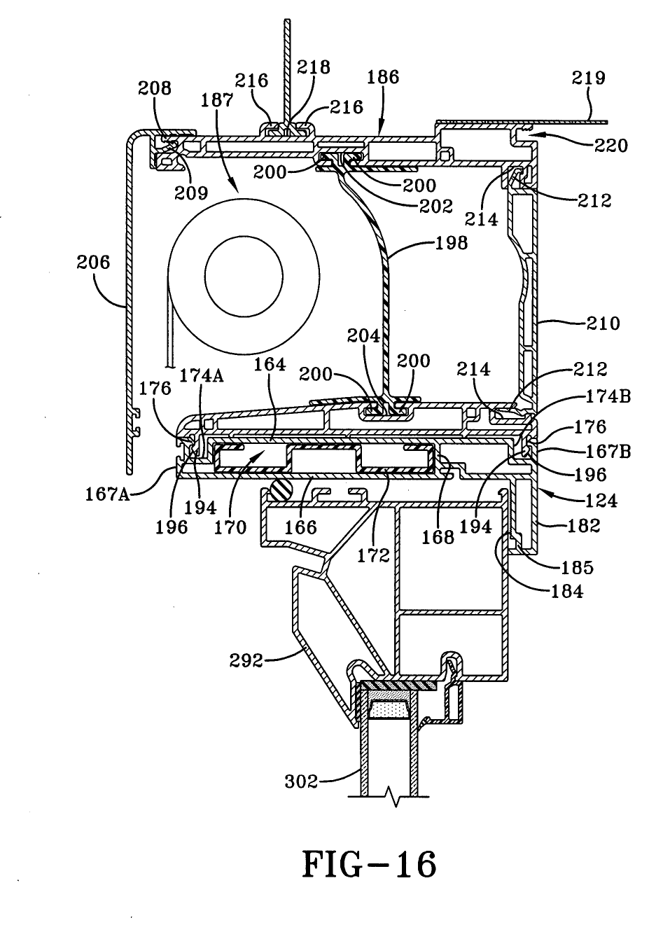

Referring now to FIGS. 15 and 16, top rail 124 is generally rectangular in end view and includes spaced top and bottom walls 164 and 166 that terminate at side walls 167a and 167b. One or more support walls 168 may be provided between side walls 167a and 167b. A longitudinally extending chamber 170 may formed inside top rail 124 that may receive an insert 172 therein. Insert 172 may provide additional structural support and rigidity to top rail 124. A pair of retaining grooves 174a and 174b extend longitudinally along opposed ends of top wall 164. Retaining grooves 174 are provided to allow easy attachment of a housing 186, as will be hereinafter discussed in more detail.

A sealing area 182 extends downwardly from bottom wall 166 and is contiguous with sealing area 158. Sealing area 182 may include a ribbed surface 184 that faces exteriorly. A groove 185 is located on the bottom side of ribbed surface 184 and both groove 185 and ribbed surface 184 are provided to receive an application of a sealing compound and/or industrial adhesive during installation of window assembly 15.

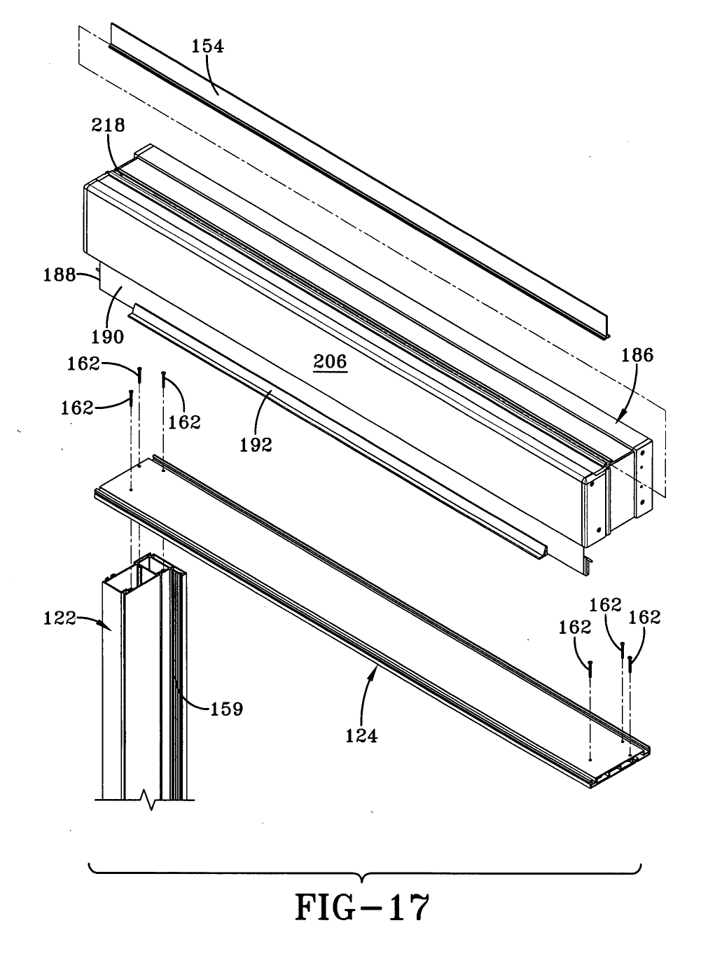

Housing 186 is positioned on top of top rail 124 to provide a chamber 187 that carries a curtain assembly 188 therein. As discussed above and shown in FIG. 17, curtain assembly 188 may include a curtain 190, bottom locking bar 192 and electrical or manual means to move the curtain assembly 188. A plurality of protrusions 194 extend from the bottom surface 195 of housing 186 and are received within retaining grooves 174. Protrusions 194 include barbs 196 that engage fingers 176 along retaining groves 174 to couple housing 186 securely to top rail 124.

Chamber 187 may be separated internally by a dividing wall 198 which may be integral with housing 186 or may be detachably installed by inserting L-shaped feet 200 into top and bottom grooves 202 and 204 respectively. Front access to chamber 187 is provided by a front cover 206 that is detachably secured to housing 186 by clip portions 208 that are positioned in receivers 209 on the forward edge of housing 186. Rear access to chamber 187 is provided by a rear cover 210 that is detachably secured to housing 186 by clip portions 212 that are positioned in receivers 214 along the top and bottom edge of housing 186.

A pair of L-shaped legs 216 are located at the top of housing 186. Legs 216 face each other and run along substantially the entire length of housing 186 to define a channel 218 that may selectively receive the head 152 of one or more fins 154. Additionally, one or more clips 219 may be adhered or otherwise fastened to the top of housing 186. Fasteners (not shown) may be driven through clip 219 and into structure 14 to secure frame assembly 120 to structure 14. A ribbed notch 220 may be provided along the top rear edge of housing 186. Notch 220 faces the interior of the structure and may receive and retain a decorative trim or other decorative feature.

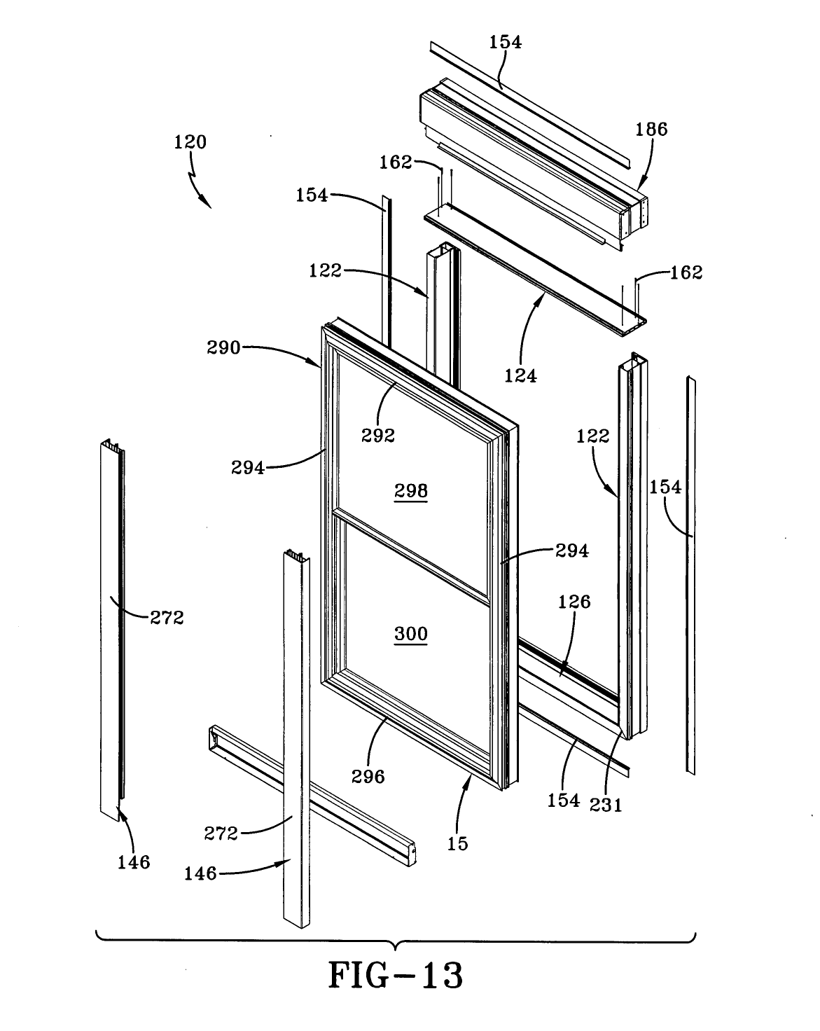

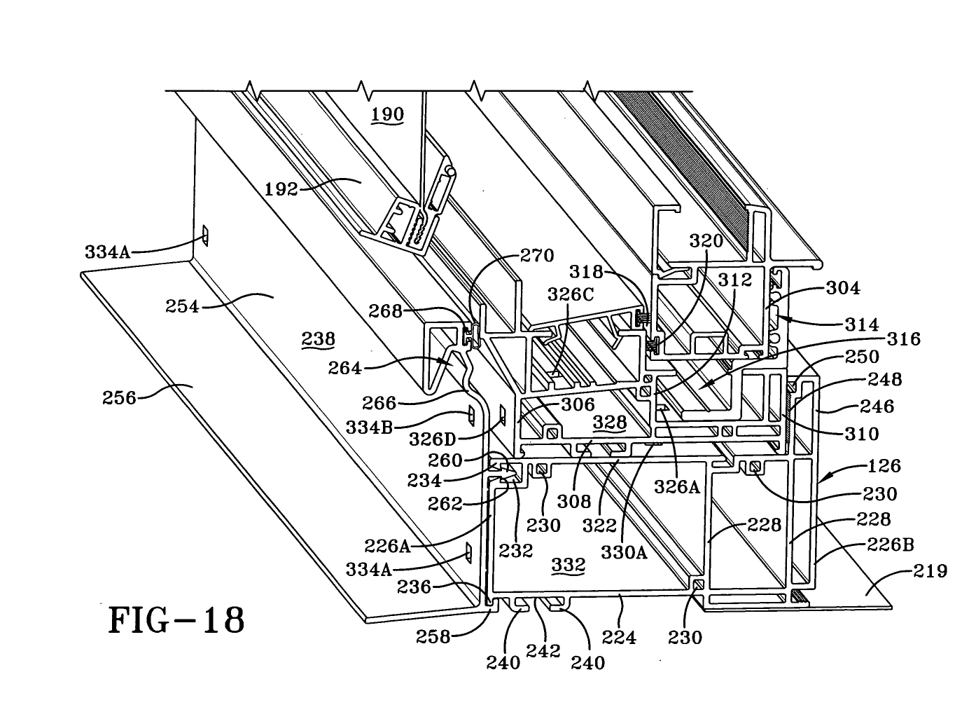

As best shown in FIG. 18, bottom rail 126 may include substantially the same cross-sectional shape as vertical rails 122 and includes a top wall 222, a bottom wall 224 and opposed side walls 226a and 226b. One or more vertically oriented dividing walls 228 are positioned between side walls 226 to provide added strength. Fasteners' (not shown) may be received through vertical rail 122 and into a pair of fastener apertures 230 to secure vertical rails 122 and bottom rail 126 together. In the present embodiment, fasteners are not used to secure together vertical rails 122 and side rails 126. Instead, each rail is cut at a forty five degree angle, and hot welded together along a seam line 231 (FIG. 13).

A forwardly facing receptacle channel 232 is located proximate to the intersection of top wall 222 and side wall 226a of bottom rail 126. Receptacle channel 132 extends substantially the entire length of bottom rail 126 and includes a pair of inwardly facing fingers 234. A protrusion 236 extends downwardly from side wall 226a. As will be hereinafter described in more detail, receptacle channel 132 and protrusion 236 cooperate to retain a locking element 238.

A pair of L-shaped legs 240 face each other and run along substantially the entire length of bottom wall 224. Legs 240 define a channel 242 that may selectively receive the head 152 of one or more fins 154. Additionally, one or more clips 219 may be adhered or otherwise fastened to the top of housing 186. Fasteners (not shown) may be driven through clip 219 and into structure 14 to secure frame assembly 120 to structure 14. A ribbed notch 244 may be provided along the intersection of bottom wall 224 and side wall 226b. Ribbed notch 244 faces the interior of the structure and may receive and retain a decorative trim or other decorative feature.

A sealing area 246 extends upwardly from top wall 222 and is contiguous with sealing area 158. Sealing area 246 may include a ribbed surface 248 that faces exteriorly. A groove 250 is located along the top side of ribbed surface 248 and both groove 250 and surface 248 are provided to allow an application of sealing compound and/or industrial adhesive during installation of window assembly 15.

The manner in which window assembly 15 is secured within frame assembly 120 will now be described in detail. Vertical rails 122, bottom rail 124 and top rail 126 are assembled together in the manner discussed above. Housing 186 may then be secured to top rail 124. With the rails 122, 124, 126 and housing 186 secured together, the window assembly 15 may be inserted into frame assembly 120. Sealing and/or adhesive materials may be applied to ribbed surfaces 159, 184 and 248, as well as along grooves 161, 185 and 250 prior to insertion. Window assembly 15 is positioned proximate to sealing areas 158, 182 and 246 as shown in FIGS. 14, 16 and 18 so that sealing/adhesive materials reside between sealing areas and the window frame. In this manner, an effective environmental seal is achieved. Further, if adhesives are used, the window assembly 15 is now securedly attached to frame assembly 120.

Once window assembly 15 is positioned proximate to sealing areas 158, 182 and 246, a pair of side guides 146 and locking element 238 may be installed. Referring now to FIGS. 13 and 18, locking element 238 may extend substantially the entire length of bottom rail 126 and includes a vertical wall 254 and a horizontal wall 256 extending outwardly from the bottom of vertical wall 254. An L-shaped tab 258 extends from the area of intersection of vertical wall 254 and horizontal wall 256 toward bottom rail 126 along substantially the entire length of locking element 238. L-shape tab 258 engages protrusion 236 to hold locking element 238 to bottom rail 126. Likewise, an arrow shaped insert 260 extends along substantially the entire length of locking element 238 and is received in receptacle channel 232. Fingers 234 engage barb portions 262 to hold locking element 238 to bottom rail.

Locking element 238 includes a locking channel 264 adapted to selectively receive a locking bar 192 therein. When bar 192 is received within channel 264, the curtain 190 thereafter protects the window assembly 15. Specifically, curtain 190 prevents penetration of projectiles that may otherwise compromise the environmental seal created by window assembly 15. It should be appreciated that other methods of locking bar 192 of curtain 190 to frame assembly 120 may be employed and that locking channel 264 is exemplary of just one such method.

As shown in FIG. 18, an upstanding portion 266 of locking element 238 extends upwardly beyond wall 222 and consequently, once secured to bottom rail 126, window assembly 15 is captured between sealing area 246 and upstanding portion 266. Upstanding portion 266 may include a channel 268 that receives a compressible seal 270 therein which engages window assembly 15 in order to positively capture window assembly and also accomplish an environmental seal.

Referring now to FIGS. 13 and 14, side guides 146 extend along vertical rails 122 and may overlap the ends of bottom rail 126. Side guides 146, in cross-section, include a front wall 272 and a rear wall 274 joined by a side wall 276. Walls 272, 274 and 276 define a vertically extending channel 278. When installed, channel 278 may receive and guide curtain 190 and/or a portion of bar 192 of curtain assembly 188.

Side guide 146 includes an arrow shaped insert 280 that extends along substantially the entire vertical length of vertical rail 122 and is received in fastening channel 138. Fingers 140 engage barb portions 282 to hold side guide 146 to vertical rail 122. Likewise, a leg 284 extends inwardly from rear wall 274 and includes a generally U-shaped receptor 286 that engages protrusion 144 to hold side guide 146 to vertical rail 122.

As shown in FIG. 14, a portion of rear wall 274 extends laterally inward beyond vertical rail 122 and consequently, once secured to vertical rail 122, window assembly 15 is captured between sealing area 158 and rear wall 274. As shown in FIG. 13, front wall 272 and side wall 276 may extend downwardly past rear wall 274 so that it overlaps an end portion of locking element 238.

In this manner window assembly 15 may be secured to frame assembly 120 by side guides 146 and locking element 238. Window assembly 15 may further be secured with adhesives and sealants as discussed above. Finally, mechanical fasteners may be driven through the jambs of window assembly 15 and into frame assembly 120 to secure it thereto. In addition to capturing window assembly 15 within frame assembly 120, side guides 146 and locking element 238 further provide guiding and locking functions for curtain assembly 188.

The entire assembly may then be inserted into opening 12 and secured to structure 14. As discussed above, frame assembly 120 may be secured to structure 14 by driving fasteners through fins 154 and into structure 14. Fasteners may also be driven through the first and second walls 128 and 130 of vertical rails 122 and into structure 14. Other methods of attachment may include the use of other mechanical fasteners and/or adhesives.

An additional feature of the present invention is its resistance to water wicking. Referring now to FIGS. 13 and 14, window assembly 15 includes an outer support structure 290 including a head 292, a pair of vertical stiles 294, and a sill 296. The outer structure 290 supports an upper sash 298 and a lower sash 300 wherein at least the lower sash is movable within outer structure 290. Lower sash may include a sealed double pane glass assembly 302 that is carried in a frame including a bottom pull rail 304. When the window is closed, bottom pull rail 304 is received in sill 296.

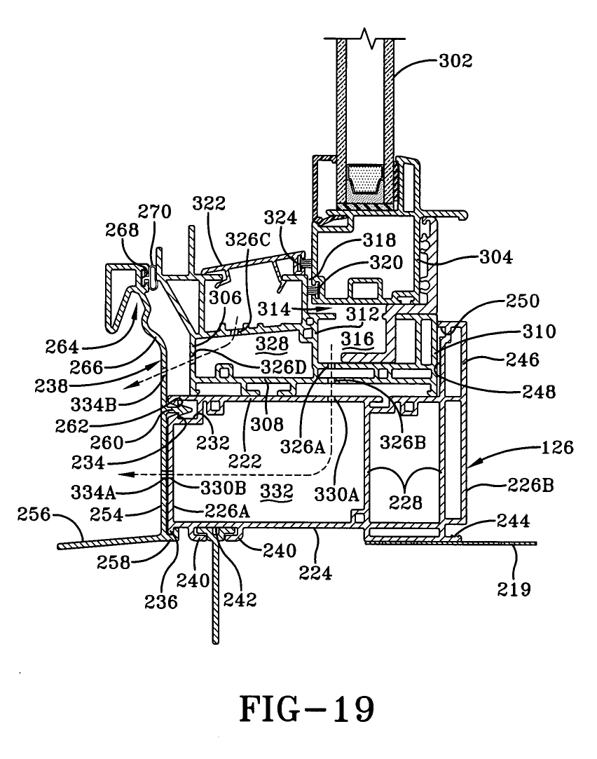

As shown in FIG. 19, sill 296 includes a front wall 306, a bottom wall 308 and a rear wall 310, as well as a plurality of internal support walls 312. A receptacle 314 is formed within sill 296 that receives bottom pull rail 304. A chamber 316 is located beneath receptacle 314 and bottom pull rail 304 is positioned in receptacle 314 such that a serpentine channel 318 is formed. Bottom pull rail 304 may include a brush seal 320 that obstructs channel 318. Further a detachable panel 322, may carry a brush seal 324 that obstruct channel 318.

During weather events that include large amounts of precipitation in conjunction with high winds, water has a tendency to pool in areas along bottom pull rail 304. If sufficient water accumulates water may be travel to the interior of the building. This occurs because water is drawn from the high pressure area (outside the window) to the relatively lower pressure area (inside the building).

The present invention prevents this water penetration by incorporating drainage apertures 326 in sill 296 that direct water out of sill 296 and into bottom rail 126. Specifically, apertures 326a are located at the bottom of chamber 316 and apertures 326b are located at bottom wall 308 to allow water to escape chamber 316. Likewise, apertures 326c are located on interior wall 312 beneath detachable panel 322 to allow water to flow into a chamber 328 in sill 296. Apertures 326d are located on front wall 306 to allow water within chamber 328 to exit sill 296.

Bottom rail 126 includes apertures 330a along top wall 222 that allow water to drain down to an inner chamber 332. Thereafter, water escapes through apertures 330b in side wall 226a and through aligned apertures 334a in locking element 238. Likewise, apertures 334b in upstanding portion 266 allow water from apertures 326d to drain out of bottom rail.

Thus, it can be seen that any water that would traverse brush seals 320 and 324 would drain down into chamber 316, and travel sequentially through apertures 326a, 326b, 330a, 330b and 334a to exit bottom rail 126 harmlessly at the exterior of the structure 14. Likewise, any water that enters sill 296 below detachable panel 322, would travel sequentially through apertures 326c, 326d and 334b to exit bottom rail 126 at the exterior of structure 14. In this manner water that would otherwise have wicked into the interior of a structure is directed out the bottom of bottom rail 126.

In view of the foregoing it should be evident that the frame assemblies made in accordance with the present invention substantially improves the art.

1. A frame assembly securable within an opening in a structure and adapted to carry a window assembly, the frame assembly comprising,
a pair of spaced vertical rails,
a top rail secured to a top end of said vertical rails, and
a bottom rail secured to a bottom end of said vertical rails,
all of said rails being adapted to engage the window assembly so that the window assembly may be removed from said frame assembly without damaging the structure.

2. The frame assembly of claim 1 further comprising a storage area is positioned at said top rail, and a protective covering carried in said storage area.

3. The frame assembly of claim 2 wherein said storage area is integral with said top rail.

4. The frame assembly of claim 2 further comprising a housing, wherein said storage area is within said housing, said housing being secured to said top rail.

5. The frame assembly of claim 4, wherein said top rail includes at least one longitudinally extending groove and said housing includes at least one protrusion, said protrusion being received in said groove to secure said top rail to said housing.

6. The frame assembly of claim 1 wherein each said vertical rail includes a first wall and a second wall, said first and second walls being spaced to increase strength and load bearing capability.

7. The frame assembly of claim 6 wherein said first and second walls are joined by at least one linking portion.

8. The frame assembly of claim 7 wherein said linking portion includes a pair of inwardly angled walls.

9. The frame assembly of claim 8 wherein said linking portion includes an integral fastener aperture.

10. The frame assembly of claim 6 wherein each said vertical rail further includes a mounting flange extending away from the opening, each said mounting flange including a plurality of notches, said mounting flange being breakable along said notches.

11. The frame assembly of claim 1 further comprising a clip, said vertical rail including a groove, said clip being secured to said groove and being adapted to receive a fastener therethrough and into the structure to secure said vertical rail to the structure.

12. The frame assembly of claim 11 wherein said clip includes a cylindrical insert, said cylindrical insert being received in said groove.

13. The frame assembly of claim 2 further comprising vertical channels extending from said top rail to said bottom rail along said vertical rails, said vertical channels being adapted to guide said protective cover.

14. The frame assembly of claim 13 wherein said vertical channels are integral with said vertical rails.

15. The frame assembly of claim 13 further comprising side guides that are secured to said vertical rails, said side guides including said vertical channels.

16. The frame assembly of claim 1 wherein each said vertical rail, said top rail and said bottom rail includes a sealing area adapted to receive a sealant to form a seal between a rear surface of the window assembly and the sealing area.

17. The frame assembly of claim 16 wherein said sealing areas are contiguous about the entire opening.

18. The frame assembly of claim 16 wherein said sealing area includes a ribbed surface adapted to promote sealing.

19. The frame assembly of claim 2 wherein said bottom rail includes a locking element adapted to selectively lock said protective cover.

20. The frame assembly of claim 1 wherein a plurality of window assemblies may be secured therein.

21. A frame assembly adapted to mount within an opening in a structure and receive a window or door assembly, the frame assembly comprising,
a pair of spaced vertical rails,
a top rail secured to a top end of said vertical rails,
a bottom rail secured to a bottom end of said vertical rails,
a storage area positioned at said top rail, and
a protective cover carried in said storage area.

22. The frame assembly of claim 21 wherein said top rail, said bottom rail and said vertical rails define an opening that is sized to fit standard window assembly sizes.

23. The frame assembly of claim 22 wherein each said top rail, bottom rail and vertical rail includes a sealing area extending into said opening and adapted to carry and sealing compound.

24. The frame assembly of claim 23 further comprising a pair of side guides and a locking element, each said side guide being secured to said vertical rail and said locking element being secured to said bottom rail, thereby capturing the window assembly between said sealing areas and said side rails and said locking element.

25. The frame assembly of claim 24 wherein said side guides include vertical channels adapted to guide said protective cover and said locking element includes a locking feature to lock said protective cover.

26. The frame assembly of claim 21 further comprising a housing, side guides and locking element, said housing carrying said protective cover, said side guides including vertical channels to guide said protective cover and said locking element including a locking feature to lock said protective cover in a closed position.

27. The frame assembly of claim 26 wherein said housing, said side guides and said locking element each include inserts that are releasably secured to said top rail, said vertical rails, and said bottom rail respectively.

28. A frame assembly adapted to mount within an opening in a structure and receive a window having a bottom sill with one or more drainage holes, the frame assembly comprising,
a pair of spaced vertical rails,
a top rail secured to a top end of said vertical rails, and
a bottom rail secured to a bottom end of said vertical rails, said bottom rail including at least one drainage passageway, said drainage passageway being adapted to communicate with the bottom sill drainage hole.
